(19) United States
(12) Patent Application Publication
(10) Pub. No.: US 2022/0076275 A1
(43) Pub. Date: Mar. 10, 2022

(54) SYSTEM AND METHODS FOR PREDICTIVE MODELING OF SEAFOOD SAFETY

(71) Applicant: Shellfish Solutions, Castine, ME (US)

(72) Inventor: Wyllys Terry, Winchester, MA (US)

(73) Assignee: Shellfish Solutions, Castine, ME (US)

(21) Appl. No.: 17/469,574

(22) Filed: Sep. 8, 2021

Related U.S. Application Data
(60) Provisional application No. 63/075,373, filed on Sep. 8, 2020.
(60) Provisional application No. 63/075,389, filed on Sep. 8, 2020.

(51) Int. Cl. G06Q 30/00; G06Q 10/08; G06K 19/06; H04L 29/08

(52) U.S. Cl. CPC G06Q 30/018; H04L 67/12; G06K 19/06037; G06Q 10/0832

(57) ABSTRACT

A system and method for predictive modeling the safety of seafood using a seafood tracking system for harvested seafood products which includes generating regulatory tags that include visual regulatory data as well as a QR Code and monitoring harvest location environment data, logistical data, location environment data, and seafood temperature to be used as inputs to help determine recommended safety levels as well triggering if additional analysis, monitoring or testing is recommended. The seafood tracking system and predictive modeling system include the ability to be updated in real-time thus enabling those with access to the QR code the ability to check food consumption recommendations for any given seafood product prior to consumption.

### COPYRIGHT STATEMENT

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### BACKGROUND

### 1. Field of the Invention

The present invention relates to monitoring data about harvested seafood product and determining if additional monitoring or testing is recommended for safe consumption.

### 2. Description of the Prior Art

Present techniques for determining safety of seafood is based on spot check temperature checks, and HACCP control plans. Some regulatory bodies are recommending ideal harvesting times to also reduce bacterium levels, which in excessive levels can cause food borne illness. However, spot checks and front-end harvesting are only a few aspects of the complex distribution of seafood from harvesters to end-consumers. Thus, the present application seeks to provide a proactive approach, as well as increasing responsiveness for responding to identified issues.

### SUMMARY

Described herein is an embodiment for a method for determining the safe consumption of harvested seafood product utilizing a networked computing device comprising the steps: receiving harvest location environment data associated with the harvested seafood product; receiving logistical data associated with travel path of the harvested seafood product; receiving location environment data of each stop along the travel path of the harvested seafood product; receiving seafood temperature data associated with the harvested seafood product; comparing each of the data types to a standard deviation; determining a weighting value of each data type based on the comparing step; determining an estimated Vibrio level using the weighted data; and comparing the estimated Vibrio level to a regulatory standard to determine safety. In other instances, other bacterium or viruses, such as salmonella, Escherichia coli (E. Coli) or even norovirus can be estimated or detected.

The above embodiment method can further comprise the step of automatically requesting additional information when any of the data types is at least one pre-determined deviation or threshold away from the mean.

The above embodiment method can further comprise the step of receiving the additional information and using the received additional information to update the weighting value of each of the data types.

The harvest location environmental data can include at least one of: ocean temperature, salinity of water, and ambient air temperature.

The logistical data can include at least one of: estimated time of travel, actual time of travel, type of transportation, type of cooling used at each leg of the trip, time taken to unload/transfer, estimated number of stops, and actual number of stops.

The location environment data includes at least one of: ambient temperature at the time and location of the harvesting, ambient temperature at each location and time of a switching point, dew point at each location, heat index at each location, cloud cover and wind speed.

The seafood temperature data can include at least one of: temperature at harvesting, time until placed into cooling storage, temperature prior to shipping, temperature at arrival, temperature while in temporary storage and temperature along the travel path using an automated data logger.

The above embodiment method can further comprise the step of determining a safety level recommendation based on the comparing the estimated Vibrio level to a regulatory standard step.

The above method can also automatically alert the user in possession to the harvested seafood product when the safety level recommendation becomes unsafe.

The safety level recommendation can be one of: fit for raw consumption, fit for consumption only after cooking, not fit for consumption.

The above embodiment method can further comprise the step further include the step of generating a QR code associated with each shipment of harvested seafood product, wherein the QR code includes a link to a database, and wherein the database is configured for storing received data from each of the data types. The QR code can be printed on a tag and displayed with the harvested seafood product where any user can scan the QR code to see the current safety level recommendation.

In another embodiment, a method for determining whether harvested seafood product requires additional investigation utilizing a networked computing device comprising the steps: receiving harvest location environment data associated with the harvested seafood product; receiving logistical data associated with travel path of the harvested seafood product; receiving location environment data of each stop along the travel path of the harvested seafood product; receiving seafood temperature data associated with the harvested seafood product; comparing each of the data types to a pre-determined deviation; generating a first alert if any of the date types go beyond a determined threshold based on the expected mean.

The method for determining whether additional investigation is needed can further include the step of generating an initial estimated Vibrio level of the harvested seafood product based on the harvested location environmental data.

The estimated arrival vibrio level can be generated base on anticipated shipping logistics and forecast weather, and wherein the estimated arrival vibrio level is compared to a regulatory standard.

In a variation once the estimated arrival vibrio level compared to a regulatory standard is within a predetermined threshold a second alert can be initiated. The second alert can include recommendations for additional monitoring or for additional testing to occur.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 illustrates a flowchart of a method of automatically tracking harvested seafood and sharing of various information from harvesting to end consumer;

FIG. 2 illustrates a schematic of various system components associated with the method of FIG. 1 for automated tracking and sharing of harvested seafood information;

FIGS. 3A-D illustrate various interfaces associated with the generating portion of the system tracker software used for inputting and generating a harvested seafood product tag and QR Code.

FIGS. 4A-D illustrate various interfaces associated with the receiving portion of the system tracker software used for receiving and further distributing of the harvested seafood product.

FIGS. 5A-C illustrate various interfaces associated with the consumer-end portion of the system tracker software.

FIG. 6 illustrates a predictive modeling method used to determine the safety of shellfish based on the various inputs and comparative steps, which may or may not trigger the need to investigate any anomalies further.

### DETAILED DESCRIPTION

Reference will now be made to the exemplary embodiments illustrated, and specific language will be used herein to describe the same. It will nevertheless be understood that no limitation of the scope of the invention is thereby intended. An initial overview of technology embodiments is provided below and then specific technology embodiments are described in further detail later. For example, shellfish safety models should not be construed to be limited to only shellfish, but can include many types of seafood and other aqua-farmed or fished products where regulatory tracking is required. It also will not be limited to Vibrio, but also applicable to other food borne illnesses, such as E. coli, salmonella or norovirus that can be introduced at harvest or in the supply chain.

As discussed above, the current state of the art related to tracking information from farmer to end consumer primarily consists of manually writing by hand physical tags to be placed on bags of shellfish. The tags are then recorded manually at the next point in the distribution chain, and a new tag is generated, manually written on and sent to the next point along the chain. This manual writing and transferring of tag information can be cumbersome and fraught with opportunity for errors. The National Shellfish Sanitation Program's Model Ordinance provides the baseline regulations for shellfish that travel across state lines or are imported from other countries. These regulations require harvester and dealer tags on every lot of shellfish and as the shellfish lots change custody, those tags shall be removed and kept for at least 90 days and ordered chronologically, and then subsequently retagged before being shipped to the next entity in the supply chain. In cases where an outbreak of shellfish related foodborne illness occurs, the tags and the accompanying log records enable tracing of the product to the original source and throughout the supply chain to identify the cause of the outbreak. However, most tags are not kept in an organized fashion, as the process of sorting and filing physical tags can again be cumbersome, which reduces the likelihood of adherence to the sorting and retention rules. Thus, when the need arises to retrace steps, the ability to trace can be hindered by disorganization.

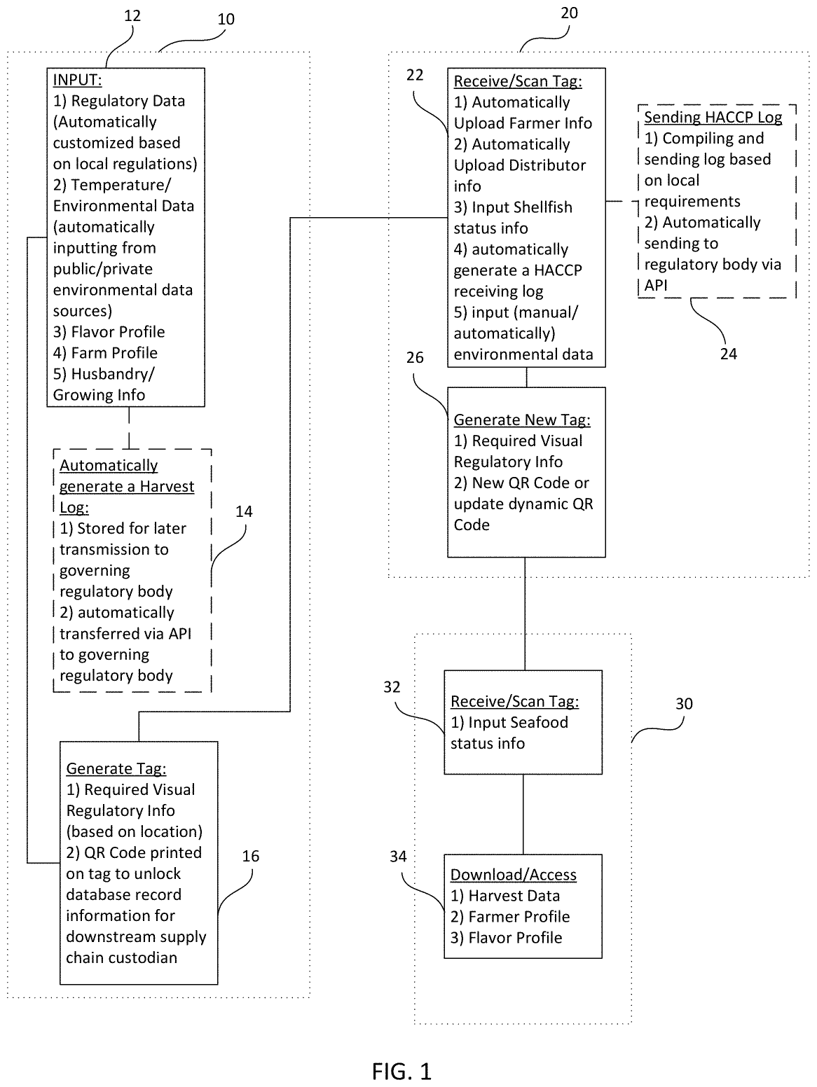

FIG. 1 illustrates a flowchart of a method for automatically tracking harvested seafood from farmer/fisherman to end consumer and additionally transferring information that is not only helpful for tracking and organizing, but providing a means of educating the end consumer more fully about the given product. By illustration at the farmer/fisherman stage 10, a smartphone or other computing device can be utilized to input and subsequently upload Regulatory Data, Environmental Data, Husbandry Data, Flavor Profile Data, and Farm Profile Data into the system during step 12.

Regarding Regulatory Data, the system can automatically populate the appropriate required regulatory data based on harvesting (or distribution/transfer) location. After populating the required regulatory data fields, the system can also pre-fill some of the fields using user profile data, location, public databases and so forth. For example, a harvester of oysters can have in their profile the name of the organization, location, certifications, website, history and other information, which can be automatically pulled in each that user is generating a new tag to be associated with a shipment of oysters to be received. The system can also automatically pull in time and location information.

Certain regulatory data such as size and quantity may need to be manually input. Certain temperature readings can be automatically updated, while others are manually entered and depend on whether the given harvester has linked sensor devices. For example, a linked temperature sensor, which monitors the temperature of the harvested product as it is stored and readied to ship. Some of the regulatory data includes determining whether or not product can be harvested at a particular time based on an issued moratoriums that may exist for a given location over a given period of time. This information is often associated with a government or regulatory body database and can be automatically checked for compliance. For example, if there is a 2-week moratorium on harvesting because of red tide, and the date of the harvesting falls within the moratorium the system can alert the user, distributor and/or regulatory body for compliance purposes. These are often referred to as growing area classifications. Other automatic verifications can include confirming that the entity/farmer/harvester is on the registered list for the FDA's Interstate Certified Shellfish Shippers List—which both the sender and receiver must be registered on if product is transported across state lines. These lists are often updated monthly and if not compliant or if a registration has lapsed fines or the destruction of the product can result. The system, upon entering the next destination, whereupon the next destination is across state lines, can automatically search and confirm appropriate registration is in place. The system is configured to automatically update any regulatory rules as changes arise.

The Environmental Data can also include the date and time the product was harvested, salinity of the water, ambient temperature, the temperature of the product, tide levels, location of the harvest product, and other environmental data. Some of this information can be automatically gathered from public and private databases. Localized environmental information can be updated from data loggers that are automatically sending hourly information to the system.

Flavor Profile Data is increasingly becoming important with regards to the seafood and shellfish industries. Consumers are increasingly becoming aware that the region, season, salinity of the waters, harvest size, time from harvest and other factors affect the taste of the harvested product. Certain restaurateurs and distributors of shellfish have begun analyzing and categorizing the various flavors associated with the harvested seafood. As with wine, the taste, flavor and consistency of the product results from the changing natural environment where it is grown. Even the same shellfish in the same bay, can have a dramatically different taste and shape depending on the time of year and the method of harvest. In the industry, this is often referred to as the Merroir. These conditions aren't complete, but are provided as an exemplary list to note the importance and value to the industry. Information at the “lot” level is an increasingly important story for consumers. For example, a story might include “the oysters were placed in the water in June of 2019. They have been handled 18 times by Joanne as she has worked to make sure they have a deep cup. The salinity of the bay this week was exceptionally high because of a Southwesterly blow. Because of the husbandry practices and environmental conditions, this particular lot of oysters is smaller with a deeper cup. They are more salty, but have our typical cucumber after taste.”

It should also be noted that various pairings of wines are now dependent on the flavors of the associated harvested product. Thus, the Flavor Profile Data can include the size and shape of the product, the salinity of the waters, the likely feed (plankton) for the shellfish and other factors and suggested pairings of drinks and other foods to be consumed with the harvested product. In some cases, recommendations on how to prepare and serve can also be included.

Additionally, Farm Profile Data can be input and uploaded into the system, which can include links to historical videos and biographical information about the owners and workers of the farm, as well as pictures of the owners and workers who manage the farm. The Farm Profile Data can help end consumers identify the source of the harvested product, and enhance the experience associated with consuming the harvested product. The Farm/harvester Profile Data can be used as a sourcing mechanism, where upon favorable or unfavorable reviews, can help increase or decrease the demand of product from a particular farm.

Husbandry Data is another set of Data that end consumers of the harvested product may be interested in. This type of data includes growing and/or harvesting techniques. For example, if the product is oysters, is it grown in cages or harvested in a natural growing environment, where does the seed come from, what time of year were they harvested, growing times, and other such data associated with the husbandry of the product.

Regulatory guidelines for tagging products do not require the Flavor Profile Data or Farm Profile Data, but as noted above, there is a value of having access to that information. As a result, this information can be input and uploaded to a database in a cloud-based system and accessed via scanning a QR Code by a networked computing device, which renders the information in a software application or in an internet browser. In one use case, the QR code is generated by the first entity using this system in the supply chain. They input and upload information about the harvested seafood product, which enables the next entity in the supply chain to access that information using a software application. That next entity can scan the QR code and then input and upload additional regulatory information pertaining to the state of the product and length of custody at their stage in the supply chain. The QR Code representing a particular lot of seafood remains the same throughout the chain of custody and is printed on the tags so that downstream entities can scan the code to determine if the tag information revealed by scanning the code meets regulatory guidelines. Often a stable lot code is generated with the associated harvested seafood product, which helps to organize and track the information in the database as information is update along the way. In some instances, a sub stable lot code is generated in the instance where a shipment is divided into smaller lots to be delivered to retailers.

Thus, once the farmer/fisherman generated a new tag for shipment, during the first step in the supply chain, that data is uploaded to the database as noted above, which enables both regulatory and non-regulatory to pass along the supply-chain, which can be revealed by scanning the QR code.

The tags can be generated during step 16 using a printer 240, such as a mobile thermal printer, configured to print on water-resistant paper, which is also generally a guideline associated with the tags, as the tags need to be able to withstand moisture and other elements during the shipping process. The generated tags can include any required visual regulatory information in addition to the scannable QR code. It should be understood that though it is referenced throughout using a QR code and that is preferred, other scannable barcodes, two-dimensional codes and so forth can be used similarly to accomplish the methods described herein. Additionally, electronic means such as RFID tags and other NFC chips could be a reasonable alternative to barcodes. Thus, the term QR code should not be construed to be a limiting term.

Each time someone new handles the harvested product in the supply chain, such as distributors 20, they can receive and scan the QR code in step 22, which similar to above loads the regulatory and non-regulatory information into their tracking system account, and enables the new entity 20 to add new regulatory information, such as time and temperature of harvested product upon arrival and then as noted above augments the database with new information which can be accessed by other downstream users, such as retailers 30, of the system by receiving and scanning the QR Code in step 32. It can also automatically pull in the second supply-chain user's information as well. This information can be transmitted from a smartphone or other networked device to a thermal printer, which can then print the updated tag during step 26, which now shows the appropriate visual regulatory information. This cycle continues until the harvested seafood product has reached its final destination, such as a grocery store or restaurant. Also similar to above, the system tracker can automatically compile and in some instances automatically send regulatory information during step 24. This is shown in dashed lines in as an optional step, and depends on local requirements.

At the final destination the end-user can scan the QR Code and access information during step 34 including the non-regulatory information, which can include the Farm Profile, Flavor Profile, Husbandry Data and even supply chain custody information that has been gathered along the way. The end-user can also have an opportunity to leave a review, which can then be received and reviewed by the farmer and/or those in the shipping channel. The restaurant or grocery store as a recipient in the supply-chain can also scan the tag, which can automatically notify the previous shipper that the harvested seafood product was received. This data can be stored in the database and accumulated for regular reporting requirements.

For example, some regulations require farmers/harvesters and dealers to submit harvest and shipment information regularly to state and federal authorities. As shown in step 14 the present system automates the transformation and transmission of that data to various databases, which can include directly sort and export that information.

Supply-chain users, which include harvesters, distributors, and retailers can have each scanned or generated tag that is associated with a given harvested seafood product shipment to be automatically tracked and associated with their business. Thus, eliminating the need to store many physical tags, and reduce the time needed to generate compliance reports. These compliance reports can include automatically generated Harvest Logs, that are often required to have on hand for a certain period of time, or in some instances to be submitted periodically. The system can compile those, store those, and certain instances automatically send them based on selected preferences using an API into the regulatory body's system.

It should also be noted that upon transitioning from harvester to the next switching point in the distribution line, upon scanning the QR code on the tag, the system can be configured to automatically generate HACCP (Hazardous Access Critical Control Point) log information, as noted above. This log information can be stored as part of compliance for the user (harvester, distributor, etc.) and sent over according to guidelines or alternatively be sent automatically upon scanning utilizing an API with the regulatory body's system.

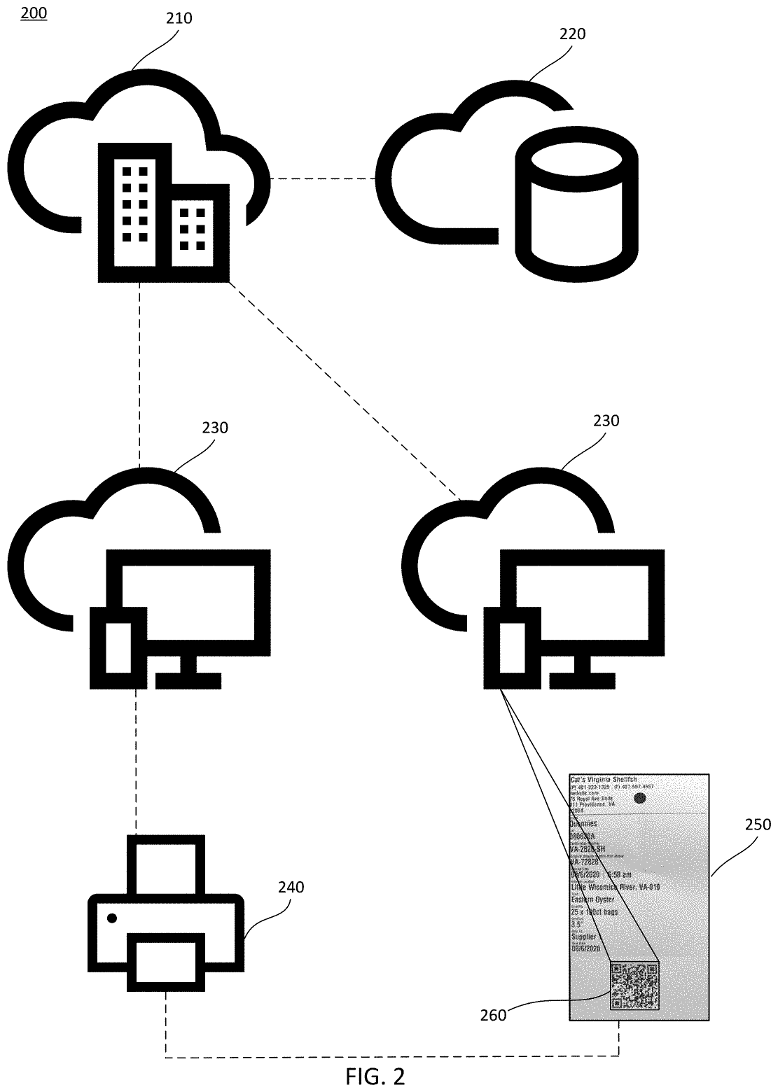

FIG. 2 illustrates a schematic of some of the tracking system 200 components that can be used to implement the methodology described above including using a smartphone device or other networked computing device 230 that has access to the internet, as well as a camera for scanning QR codes. The smartphone device 230 can access the system software, which can locally available on the smartphone, available in a cloud-based computing device 210, or implemented as a hybrid of the two. This tracking system software can be used for manually inputting or otherwise automatically gathering the regulatory and non-regulatory information, which is stored in a database 220 and associated with the harvested seafood product. Each user/company of the system can have an associated user ID that includes profile information to enable auto-filling for some of the regulatory and non-regulatory information. The tracking system software is configured to enable links, videos, pictures and biographic information, as well as reviews from end-users which can be added to the database and associated with the specific QR code. As shown, more than one smartphone or networked computing device can be used as a portal to access the information associated with the QR Code and for updating additional information to be associated therewith. As noted previously, 230 can be used to scan a printed tag 250 having a QR code 260 displayed thereon to begin accessing information associated with that QR code.

Computing device 210 can include a processor and non-volatile memory, which includes executable instructions stored thereon to perform many of the tasks already herein. Some of those tasks include receiving data from 230 and sending the received data to database 220. Other tasks include verifying the user based on received scanned information, retrieving from external databases regulatory, environmental or other externally retrieved data and associating it with a particular harvested seafood product shipment or lot.

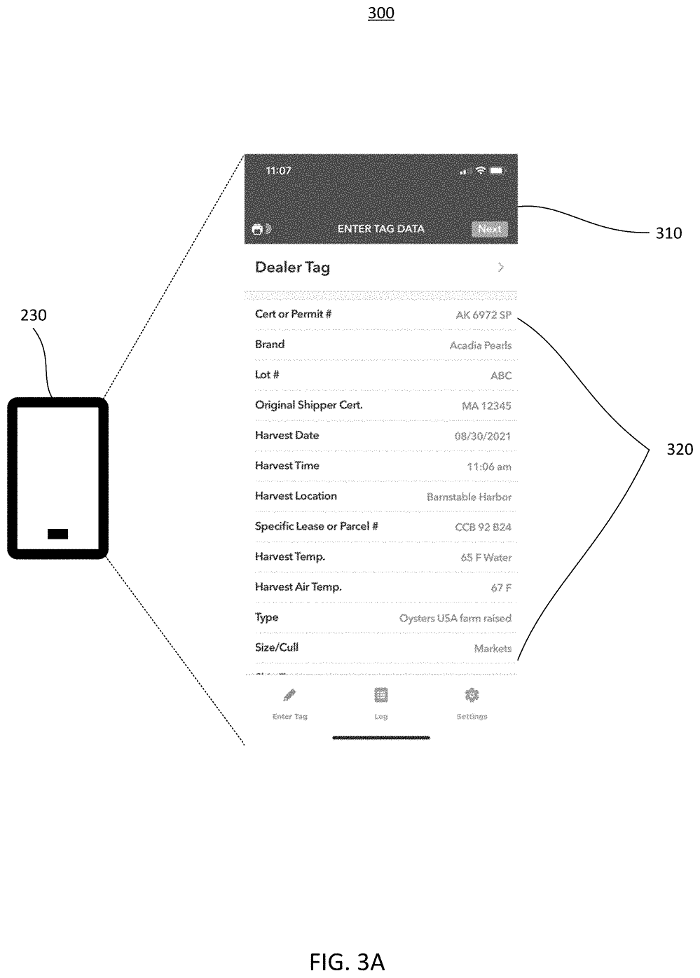

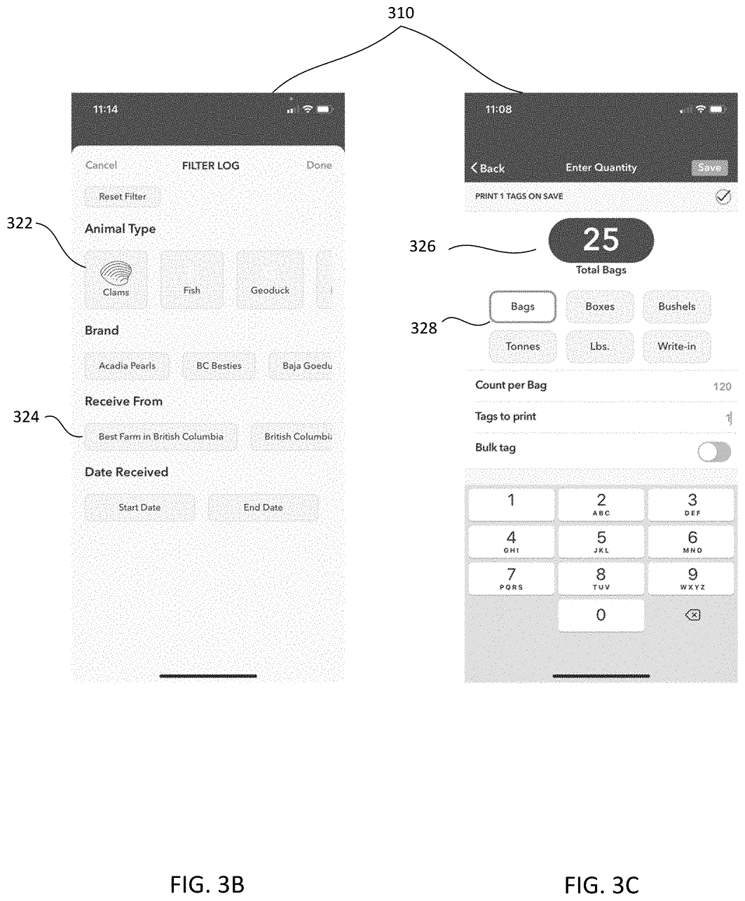

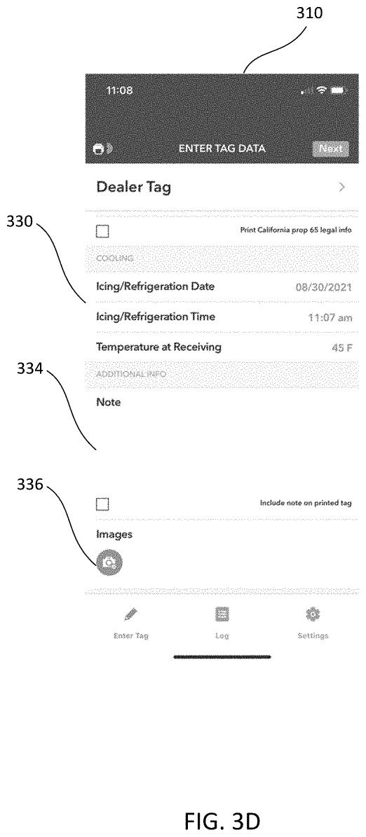

FIGS. 3A-D illustrate various interfaces associated with the generating portion 300 of the system tracker software used for inputting and generating a new harvested seafood product tags and QR Code. Displayed on the smartphone 230 is user interface 310, which can include various regulatory fields 320, some of which can be automatically generated and some of which might require manual input. FIGS. 3B-C illustrate additional views of the interface 310 that include options for filtering the type of seafood 322 to be shipped, as well as the location selection option 324 where the product was received from. Some harvesters/fisherman may have multiple types and locations from which they harvest various seafood products. In FIG. 3C, fields for quantity 326 including the container style fields 328 can be selected. FIG. 3D illustrates temperature fields 330 from the product being stored prior to shipping, as well as note field 334 that be used to generated a particular note on the tag, and a field 336 to upload images, which can be helpful in many ways and later retrieved downstream upon scanning the QR Code. Once the appropriate data fields have been inputted either through manual or automatically generated, a tag can be generated to be shipped with the harvested seafood product. It should be understood that the tag can be waterproof, it can be in the form of sticker, and come in various sizes.

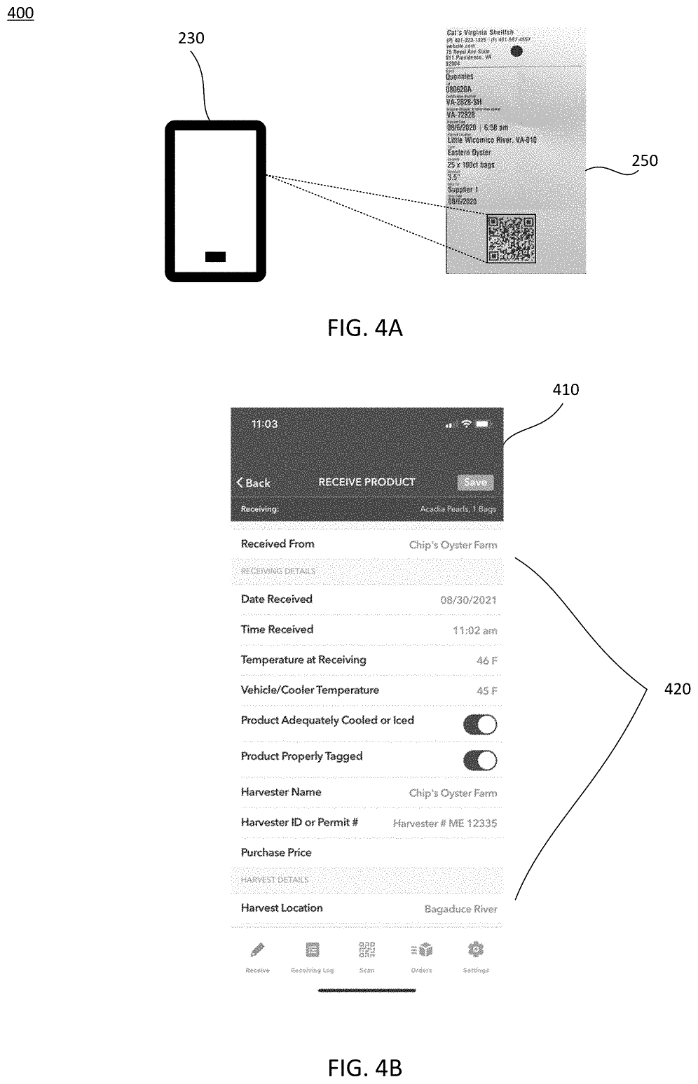

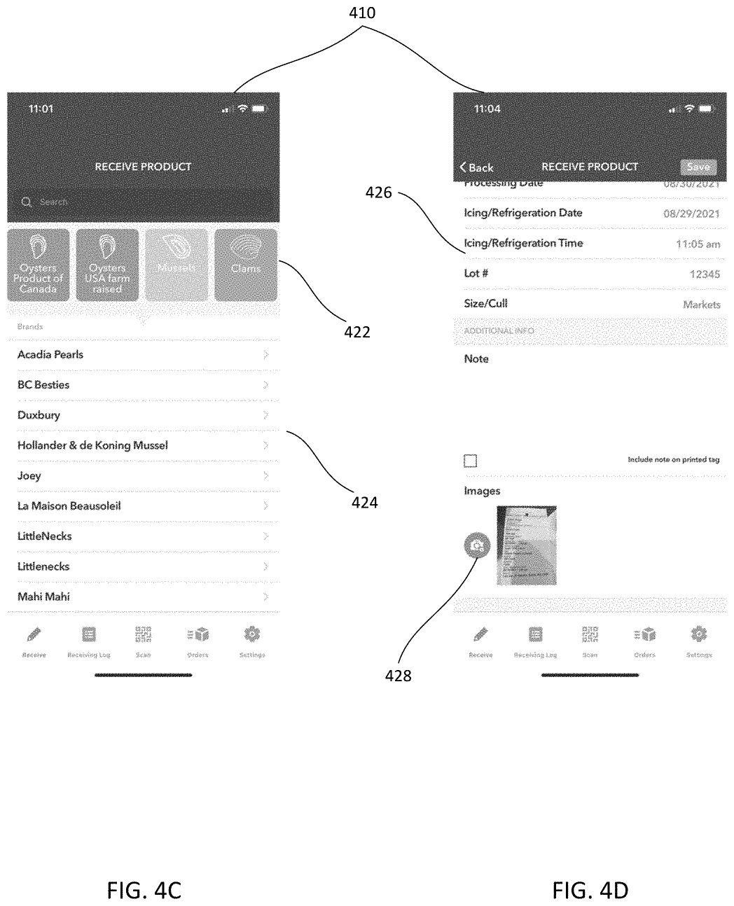

FIGS. 4A-D illustrate various interfaces associated with the receiving portion 400 of the system tracker software used for receiving and possibly further distributing of the harvested seafood product. As noted, smartphone 230 can scan the QR code of the received tag 250. The user interface 410 for receiving can include much of the same information including fields for inputting regulatory information. Some of this information can be automatically transferred over, while other information, such as temperature checks and quantity may need to be manually input, or received from temperature sensors. The tracking system software can also determine the current location and gather external data information, such as environmental and local regulatory requirements. The receiving user interface can also include fields to sort the type 422 of seafood products received or anticipated to be received through a filtering system, as well as specific types 424 of the given seafood product. This is helpful in understanding how much of a given item there is on hand and for coordinating further shipping. Similar to 300, 400 includes additional temperature information fields 426 to be updated of the product upon arrival, during the transition and before departing to a new location, if it is not the final destination. Uploading picture fields 428 are also available to document the product, which can be part of the record uploaded and saved to the remote database 220.

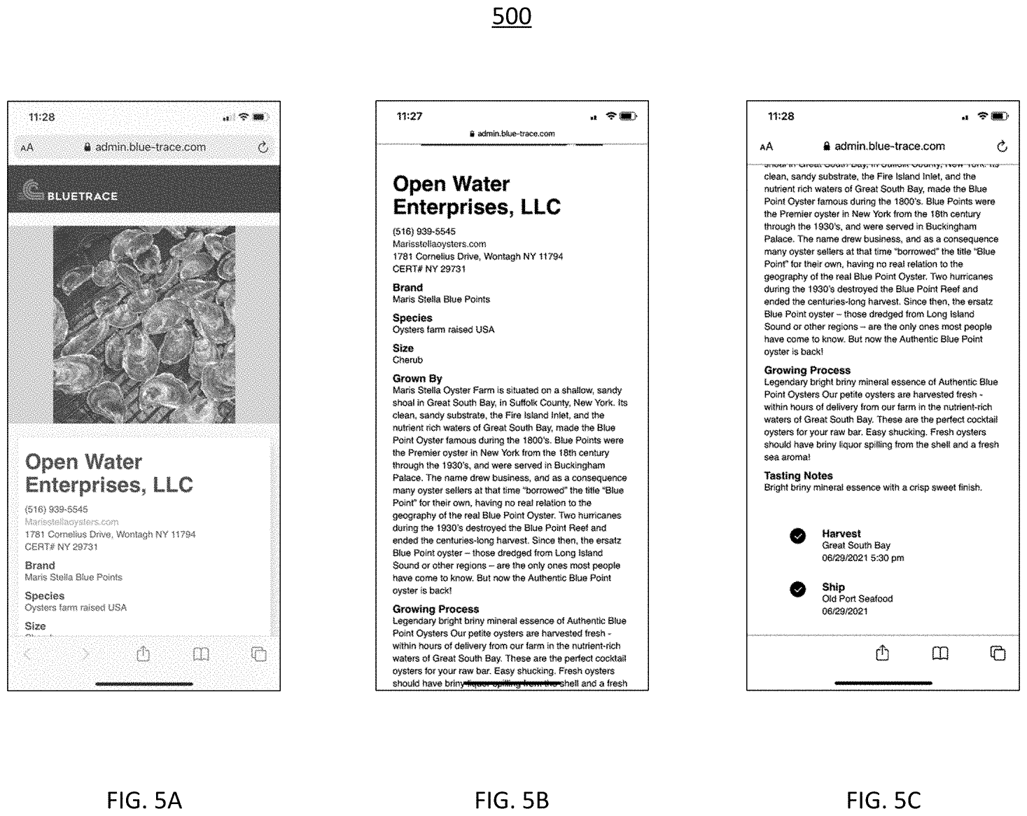

FIGS. 5A-C illustrate various interfaces associated with the consumer-end portion 500 of the system tracker software. These can display the various non-regulatory information mentioned above including information pertaining to the particular harvester/fisherman, history of the entity, husbandry of the product, recommended food pairings, such as wine pairings for the product, and so forth. This information can even guide users how to prepare the given harvested seafood product, as water salinity, type of product, time of year and many other factors can affect the product, very similar to grapes grown in various regions around the world.

Another one of the advantages of the present methods and systems include rapidly responding to any food contamination incidents. For example, if a particular restaurant prepares a seafood item where it was identified that individuals got sick from, they could rapidly make a note in the tracking system for that particular received shipment, which then becomes part of the recorded data instantly. This can trigger a warning to other locations where this particular lot of seafood may have been shipped. In the case of consumers who buy the product from the grocery store for home use, they could scan the QR code prior to use to see if the consumption recommendation has changed. As noted, the consumption rating could include a recommendation that is indicative for consuming the product raw, a recommendation that states the product needs to be cooked prior to consumption, or a warning that the product should be disposed of and not consumed. In some embodiments, anyone in the supply-chain, consumers and regulatory users can each make a note that is pushed out to those who were part of the supply chain process. Thus, helping to reduce potential additional food poisoning cases, without the need to unduly dispose of every lot of seafood. This could also help isolate potential other lots or containers of seafood that might have traveled together to be tested.

For example, if oysters traveling on a truck with clams and mussels were found to have high amounts of vibrio bacteria, the system could trigger an alert for those claims and mussels to be further tested or for a possible warning to be associated with them. It may even trigger an automatic reduction in the consumption recommendation from consuming raw to consuming only after cooking until or unless further testing verifies the safety of the lot.

As noted, depending on the type of user scanning the QR code can determine the type and amount of information available. As discussed above, harvesters that have an app or running the tracking software and have a user login can generate and track their product through the process. Distributors and Retailers can also get notifications that shipments are to arrive and see the regulatory data, because they likewise are running the tracking software application and have a distributer or retailer login, whereas the consumer who simply scans the QR code using a standard camera app on their smartphone is directed to a public browser-based website that does not include the same regulatory and shipping information. In some instances, it may include where the product traveled from.

It should be noted the tracking software can be configured to utilize GPS information from a smartphone, IP address information, as well as any other sensor information that might be pertinent to expediting and accurately tracking the harvested seafood product.

### Predictive Seafood and Shellfish Safety Modeling

According to the U.S. Centers for Disease Control and Prevention (CDC), an estimated 35,000 Americans got sick in 2019 from Vibrio p. transmitted by shellfish. Vibrio is the leading cause of seafood-related bacterial infections globally and the number of reported cases increased 54% from 2006 to 2017 (Abanto, M, Emerging Infectious Diseases, February 2020). Temperature abuse is one of the largest factors in Vibrio outbreaks and according to a recent study 18% of oyster shipments in the US suffered temperature abuse for at least an hour. (Love, Kuehl, et al. 2019),

Once an illness is reported, the FDA and state regulators must trace back through the system to identify what shellfish were responsible and where the problem started. According to a member of the ISSC, the average traceback takes over 2 weeks, and over 50% of traceback attempts fail to identify the source because at some point in the chain the records are incomplete or unreadable. Even when the traceback succeeds, the slowness of the process means that other product from that lot has already been consumed or disposed of, making this an ineffective approach to containing outbreaks.

Utilizing some of the same methods and systems as noted above, a predictive seafood modeling method and system can be implemented. For example, the automatic tracking of shellfish and temperature information utilizing the embodiments of FIGS. 1-5 provides critical data that can be combined with known Vibrio growth data to predict the amount of Vibrio in the shellfish. To further illustrate this point, the following example is provided:
1. July 1st, 7 am: Best Oysters in Milford Conn., harvests 100 bags of oysters (100 ct/bag)
   a. The ambient temperature was 62 degrees and they were put on refrigeration within 5 hours
   b. According to the NOAA tracker: at that time, date, place and with that cooling strategy Vibrio will double every 5.32 hours.
2. July 1st, 12:30 am Oysters arrive at Shellfish Broker in Norwalk, Conn.
   a. Ambient temperature, 75 degrees. Temp check of product shows 38 degrees.
   b. They are put into refrigeration
3. July 2nd, 5:30 am they are put on a truck to Boston.
   a. Temperature of truck is 42 degrees
4. July 2nd 8:30 am Arrive at Araho in Boston.
   a. Temp of truck is 43 degrees
   b. Product is 38 degrees
5. July 2nd 10 am: Put on a flight to Atlanta—
   a. Temp check at arrival shows product at 50 degrees
   b. Put back in refrigeration at Inland Seafood.
6. July 3rd: Split into 20 orders and delivered to 20 different restaurants.

If all goes well those shellfish will be safe; however, there can be issues that arise. Some data points that can be utilized to determine the safety of the shellfish includes utilizing Harvest Environment Data, Logistical Data, and Location Environmental Data and Shellfish Temperature Data. Once each of these data sets are gathered, they can be compared against a pre-determined deviation or threshold to determine if the data is outside of the pre-determined deviation or threshold. For example, if trucking shellfish from Boston to Ohio usually takes 14-16 hours, but the recorded time was 25 hours that may trigger the system to request information on the cause of the delay. In conjunction, we compare the ambient temperature and other factors such as temperature at harvest, prevalence of Vibrio at harvest, time since harvest and other data to score this lot and determine the level of risk. This logistical data information can then have its weighted value as part of the overall predictive model be modified based in part on the actual comparison step and additional information provided as a result of any triggered investigation. Once the weighted values of each of the Data types has been determined, the estimated Vibrio levels can be determined and compared with health and safety values to determine whether or not the harvested product should be consumed or if any additional steps should be taken to ensure a safe consumption of the product. For example, if the Vibrio levels are determined to be too high, the product may be unsuitable for raw consumption, but suitable in a cooked form, so long as appropriate cooking times and temperatures are achieved. Alternatively, the product may undergo certain techniques, such as rapid cooling for a period of time to bring the estimated Vibrio levels down to an acceptable range.

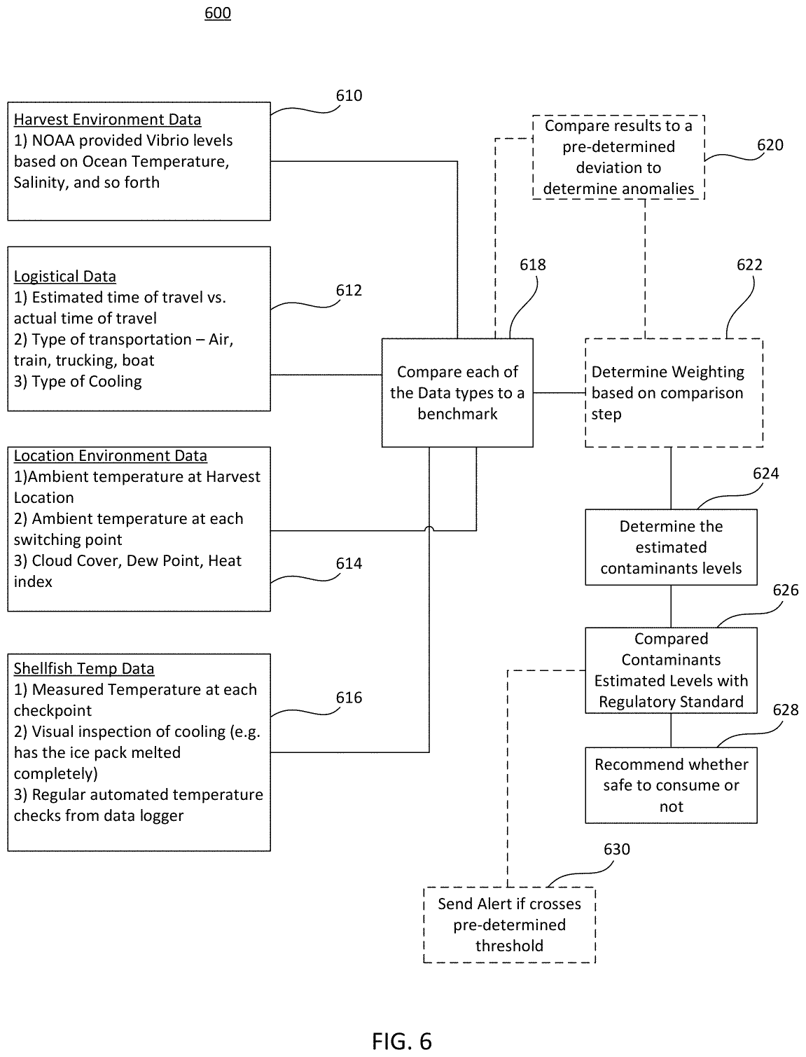

FIG. 6 illustrates a flow chart of the predictive modeling and recommendation method 600 used to determine the safety of shellfish or trigger an alert for additional monitoring or testing. Each of the types of Data (noted above) and shown as inputs 610, 612, 614 and 616 are analyzed and compared against a benchmark during step 618, once that is completed an additional comparison step to a pre-determined deviation or threshold step can occur, which can in part determine if further investigation is required or whether the product should be flagged for additional scrutiny can be made in step 620. This is done by analyzing the benchmark comparison to a pre-determined deviation or threshold. The weighted factoring 622 of each of the types of Data can be modified based on the comparative step 618 and/or based on step 620, which can include additional information resulting from an investigation. The flagging of a potential anomaly in 620 can be enough to influence the weighting factoring of step 622. Once updated, an estimated level of contaminants (such as Vibrio) can be determined 624 and compared against a health and safety regulatory standard 626 to determine the safety of the product. Once the comparison step 626 occurs an additional recommendation step 628 can be provided that includes whether the harvested seafood product is: fit for consumption, fit for consumption only after cooking, or not fit for consumption. If during the contaminants comparison step 626 comes within a predetermined threshold that could trigger a second alert 630, which could be sent to those involved in the supply-chain or regulatory persons. The second alert could include a recommendation to further investigate, monitor or test the harvested seafood product. Since this monitoring and data is constantly being updated, an alert or change of status regarding the consumption safety can be updated at any time. One of the advantages of using QR codes on the harvest tags and continually using those QR codes through the entire process is at any point anyone can scan the QR Code and see the latest recommended safety levels. For instance, a lot of shellfish might be safe at 7 am, but if left until 9 am in the heat of the day they would likely be unsafe.

For purposes of this application, it should be understood that the benchmark for which the data types are compared to can be based on historical data, which could be an expected result, range or formula, or also based on a regulatory standard, which again could be an expected result, limit, range, or formula. As more data is run through the system, these benchmarks can be updated automatically. Similarly, if the regulatory standards change the benchmarks could again be updated.

If a consumer does get sick based on Vibrio, the tracing can be expedited as result of the automated tracking system and the predictive method can be utilized to see if any anomalies were flagged. With each tracing, the details of how the levels got too high can be updated in the predictive model and further modify the weighting of each type of Data, as well as updating the benchmarks or trigger points to alert the system of potential areas to investigate prior to serving or delivering the harvested product to the next phase, or alternatively appropriately receiving the harvest product into inventory at all.

It should also be noted that the predictive model 600 for safety consumption can include a learning algorithm that updates both the benchmark information as well as the pre-determined deviation or thresholds as more data is analyzed and received. For example, if there is a heat wave in a particular region, and the number of reported instances of food borne illness increased as a result of product from that area, the predictive model might reduce the pre-determined deviation for measured seafood temperature range or weight the harvest location environment data higher when a future heat wave in another area occurs. The predictive model for safety can also include a Bayesian algorithm, which could be incorporate as part of steps 610-622.

For example, during step 618 the benchmark range can be reduced for the amount of time between changing of ice, as a result of the heat wave. Alternatively, or additionally, the refrigerant system on a truck could be changed from one having less cooling capacity to one having increased cooling capacity. The pre-determined deviations or thresholds in 620 can also be affected, which again have an influence on the weighting step 622.

Another aspect of the embodiments and methods above includes the ability to monitor and confirm changes, which results in the reduction in fraud and manipulating of information. For example, if the harvester tags a bag of oysters with a quantity of 200 and the distributor receiving that bag counts only 100 and enters into the system 100 an error flag is generated. This can be resolved by the harvester and distributor confirming where the error occurred, which could include accidentally putting in the wrong number, forgetting to load an extra bag, the driver dropping off a bag at the wrong location or something else. Once the error is corrected it becomes part of the record on how it was resolved.

Other forms of manipulation could include where a distributor changes the actual harvesting date by a few days to ‘extend’ the shelf life of the particular product. Again, if the distributor entered a later harvesting date, the system would again flag it and it would continue to perpetuate down the line until resolved. In yet another example, a particular farmer could be under a moratorium for a couple of weeks, but that product is still being ‘sold’ at a particular restaurant. By having the ability for consumers or servers to scan the QR code of the desired product they could be alerted that the product is temporarily unavailable. This auto-error detection function, which compares entered information from one location in the supply chain to the next is a way of tracking errors and their resolutions, which reduces the amount of fraud, miscounting, manipulation and possibly even help identify theft.

In summarizing some of the advantages of the methods and systems described herein, it should be noted that these methods and systems increase efficiency of regulatory compliance, eliminate the need to chronologically order tags and keep on hand for a specified period of time, improve safety through multiple ways of reporting, instant alerting and updates, as well as increase marketing and product awareness not previously obtainable through the supply-chain process. With the information stored in a database and accessible from the cloud servers of the tracking system, the user can also filter and sort in additional ways that can increase productivity and eliminate waste. The user can also utilize the information for planning purposes and anticipate seasonal and other types of features, which can be useful for selling and consuming the harvested seafood product.

Additional advantages related to the predictive model for safety consumption should be apparent, but include reducing food borne illness cases through detecting potential anomalies that could contribute to the safety consumption level of the harvested seafood product being affected.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

1. A method for determining the safe consumption of harvested seafood product utilizing a networked computing device comprising the steps:
receiving harvest location environment data associated with the harvested seafood product;
receiving logistical data associated with travel path of the harvested seafood product;
receiving location environment data of each stop along the travel path of the harvested seafood product;
receiving seafood temperature data associated with the harvested seafood product;
comparing each of the data types to a benchmark;
determining a weighting value of each data type based on the comparing step;
determining an estimated Vibrio level using the weighted data; and
comparing the estimated Vibrio level to a regulatory standard to determine safety.

2. The method for determining the safe consumption of harvested seafood product utilizing a networked computing device of claim 1, further comprising the step of comparing the benchmark comparison to a pre-determined deviation or threshold.

3. The method for determining the safe consumption of harvested seafood product utilizing a networked computing device of claim 2, further including the step of requesting additional information or updating the weighting value of each of the data types if the pre-determined deviation or threshold is met or exceeded.

4. The method for determining the safe consumption of harvested seafood product utilizing a networked computing device of claim 1, wherein the harvest location environmental data includes at least one of: ocean temperature, salinity of water, and ambient air temperature.

5. The method for determining the safe consumption of harvested seafood product utilizing a networked computing device of claim 1, wherein the logistical data includes at least one of: estimated time of travel, actual time of travel, type of transportation, type of cooling used at each leg of the trip, time taken to unload/transfer, estimated number of stops, and actual number of stops.

6. The method for determining the safe consumption of harvested seafood product utilizing a networked computing device of claim 1, wherein the location environment data includes at least one of: ambient temperature at the time and location of the harvesting, ambient temperature at each location and time of a switching point, dew point at each location, heat index at each location, cloud cover and wind speed.

7. The method for determining the safe consumption of harvested seafood product utilizing a networked computing device of claim 1, wherein the seafood temperature data includes at least one of: temperature at harvesting, time until placed into cooling storage, temperature prior to shipping, temperature at arrival, temperature while in temporary storage and temperature along the travel path using an automated data logger.

8. The method for determining the safe consumption of harvested seafood product utilizing a networked computing device of claim 1, further including determining a safety level recommendation based on the comparing the estimated Vibrio level to a regulatory standard step.

9. The method for determining the safe consumption of harvested seafood product utilizing a networked computing device of claim 8, automatically alerting the user in possession to the harvested seafood product when the safety level recommendation becomes unsafe.

10. The method for determining the safe consumption of harvested seafood product utilizing a networked computing device of claim 8, wherein the safety level recommendation is one of: fit for raw consumption, fit for consumption only after cooking, not fit for consumption.

11. The method for determining the safe consumption of harvested seafood product utilizing a networked computing device of claim 1, further including the step of generating a QR code associated with each shipment of harvested seafood product, wherein the QR code includes a link to a database, and wherein the database is configured for storing received data from each of the data types.

12. The method for determining the safe consumption of harvested seafood product utilizing a networked computing device of claim 11, wherein the QR code is printed or embedded on a tag and displayed with the harvested seafood product.

13. The method for determining the safe consumption of harvested seafood product utilizing a networked computing device of claim 12, wherein any user can scan the QR code to see the current safety level recommendation.

14. The method for determining the safe consumption of harvested seafood product utilizing a networked computing device of claim 2, wherein the benchmark and pre-determined deviation or threshold values are updated based on updated historical information.

15. A method for determining whether harvested seafood product requires additional investigation utilizing a networked computing device comprising the steps:
receiving harvest location environment data associated with the harvested seafood product;
receiving logistical data associated with travel path of the harvested seafood product;
receiving location environment data of each stop along the travel path of the harvested seafood product;
receiving seafood temperature data associated with the harvested seafood product;
comparing each of the data types to a benchmark based on historical or regulatory data;
generating a first alert if any of the date types go beyond a pre-determined threshold based on the benchmark.

16. The method for determining whether harvested seafood product requires additional investigation utilizing a networked computing device of claim 15, further including the step of generating an initial estimated contaminant level of the harvested seafood product based on the harvested location environmental data.

17. The method for determining whether harvested seafood product requires additional investigation utilizing a networked computing device of claim 16, wherein an estimated arrival contaminant level is generated base on anticipated shipping logistics and forecast weather, and wherein the estimated arrival vibrio level is compared to a regulatory standard.

18. The method for determining whether harvested seafood product requires additional investigation utilizing a networked computing device of claim 16, further including the step of generating a second alert if the estimated arrival contaminant level compared to a regulatory standard is within a predetermined threshold.

19. The method for determining whether harvested seafood product requires additional investigation utilizing a networked computing device of claim 18, wherein the second alert includes recommendations for additional monitoring.

20. The method for determining whether harvested seafood product requires additional investigation utilizing a networked computing device of claim 18, wherein the second alert includes recommendations for additional testing.
